(19) United States
(12) Patent Application Publication
(10) Pub. No.: US 2024/0227508 A1
(43) Pub. Date: Jul. 11, 2024

(54) A HEATING AND COOLING SYSTEM FOR A VEHICLE

(71) Applicant: Equipmake Limited, Snetterton (GB)

(72) Inventor: Aleksander Dominik MOCZEK, Wymondham (GB)

(21) Appl. No.: 18/558,638

(22) PCT Filed: May 4, 2022
(86) PCT No.: PCT/GB2022/051130

§ 371 Date: Nov. 2, 2023

(30) Foreign Application Priority Data
May 5, 2021 (GB) 2106393.8

(51) Int. Cl. B60H 1/32

(52) U.S. Cl. CPC B60H 1/3228

(57) ABSTRACT

A heating and cooling system for a vehicle, comprises a heat transfer assembly having a first heat exchanger and a second heat exchanger and configured to receive heat energy at the first heat exchanger, transfer heat energy from the first heat exchanger to the second heat exchanger and output heat energy at the second heat exchanger. The system includes a liquid coolant distribution system having a cold tank for a first liquid reservoir, a hot tank for a second liquid reservoir, and a network of fluid conduits coupling the cold tank to the first heat exchanger, the hot tank to the second heat exchanger, and the cold and hot tanks to locations in the vehicle to be heated or cooled using liquid from the tanks.

### FIELD OF THE DISCLOSURE

The present disclosure relates to temperature control in a vehicle. More particularly, it concerns increasing the efficiency of energy use to control the temperature in a vehicle.

### BACKGROUND TO THE DISCLOSURE

There is an ongoing need to reduce the environmental impact of transport. A substantial amount of energy may be consumed in controlling the internal temperature of a vehicle.

### SUMMARY OF THE DISCLOSURE

The present disclosure provides a heating and cooling system for a vehicle, comprising:
a heat transfer assembly having a first heat exchanger and a second heat exchanger and configured to receive heat energy at the first heat exchanger, transfer heat energy from the first heat exchanger to the second heat exchanger and output heat energy at the second heat exchanger, and
a liquid coolant distribution system comprising:
   a cold tank for a first liquid reservoir;
   a hot tank for a second liquid reservoir; and
   a network of fluid conduits coupling:
      the cold tank to the first heat exchanger,
      the hot tank to the second heat exchanger, and
      the cold and hot tanks to locations in the vehicle to be heated or cooled using liquid from the tanks.

The system includes a heat transfer assembly or heat pump in combination with two tanks or reservoirs of liquid. One of the tanks (the “hot tank”) is provided to hold liquid at a higher temperature than the liquid held in the other tank (the “cold tank”). The heat transfer assembly is operable to transfer heat energy from the cold tank to the hot tank. The tanks thereby provide sources of liquid heat transfer medium at two different temperatures.

During operation of the system, the liquid can be used to transfer heat energy between different parts of the system so as to control the temperature of different regions of the vehicle. Use of a liquid (such as water, water mixed with glycol, or another coolant fluid) as the heat transfer medium may increase the rate of heat transfer in comparison to the use of air instead. The system thereby facilitates increased efficiency of energy use by the vehicle for temperature control.

In a known temperature control system for a vehicle, air is blown directly over the evaporator of an air conditioner to provide air cooling. Using the present system, heat energy may be transferred to or extracted from a region of vehicle using a liquid. Heat transfer may then take place in the region concerned using a liquid-air heat exchanger and/or heat transfer between a liquid heat transfer medium and a component may occur via direct contact (as opposed to using air circulation).

The inventor has determined that it can take a similar amount of energy to control the temperature of a passenger compartment in a bus to the amount consumed in driving the bus, depending on the ambient external temperature. At the same time, the inventor has recognised that a bus has other regions that require thermal management. For example, a bus driven using electrical power will have an electric motor, battery pack and inverters requiring some degree of temperature control for operation and possibly tighter temperature control to optimise their efficiency.

For example, in some ambient conditions, the passenger compartment of a bus may require heating from 15 to 20° C. whilst another region, for example the battery pack, may require cooling from 15 to 5° C.

Another factor to consider in temperature control in a passenger vehicle is that each passenger may emit around 100 W of heat energy. Therefore, a double deck bus with a capacity for 90 passengers may receive up to 9 kW of heat from the passengers in the passenger compartment. The number of passengers carried by a bus during a typical day at any one time may vary considerably and so the heating or cooling requirements for a passenger compartment may also vary considerably during the course of the day.

A heating and cooling system according to the present disclosure is able to manage the temperature distribution within a vehicle in a versatile and efficient manner.

The cold tank may be fluidically coupled to the first heat exchanger so as to enable the transfer of heat energy from liquid drawn from the cold tank to the first heat exchanger. This liquid may then return to the cold tank.

The hot tank may be fluidically coupled to the second heat exchanger so as to enable the transfer of heat energy from the second heat exchanger to liquid drawn from the hot tank. This liquid may then return to the hot tank.

Either or both of the cold and hot tanks may be fluidically coupled to a location in the vehicle to facilitate cooling and/or heating of the location using liquid from the tank(s). The liquid may then return to the tank from which it was drawn.

The system may be arranged to enable liquid to be circulated from either one of the cold and hot tanks (when either cooling or heating is required) selectively to one or more of a plurality of locations in the vehicle.

Preferably, the heat transfer assembly includes:
a third heat exchanger having first and second fluid inlets and first and second fluid outlets, wherein the third heat exchanger is arranged to transfer heat energy from fluid flowing from the first inlet to the first outlet to fluid flowing from the second inlet to the second outlet;
an expansion device;
a compressor;
a first loop of fluid conduits arranged to carry fluid from the first outlet of the third heat exchanger to the first heat exchanger via the expansion device, and then to the second inlet of the third heat exchanger; and
a second loop of fluid conduits arranged to carry fluid from the second outlet of the third heat exchanger to the second heat exchanger via the compressor, and then to the first inlet of the third heat exchanger.

This heat transfer assembly configuration may provide heat transfer in a highly efficient manner.

The present disclosure may further provide a heat transfer assembly comprising:
a first heat exchanger and a second heat exchanger, wherein the assembly is configured to receive heat energy at the first heat exchanger, transfer heat energy from the first heat exchanger to the second heat exchanger and output heat energy at the second heat exchanger;
a third heat exchanger having first and second fluid inlets and first and second fluid outlets, wherein the third heat exchanger is arranged to transfer heat energy from fluid flowing from the first inlet to the first outlet to fluid flowing from the second inlet to the second outlet;
an expansion device;
a compressor;
a first loop of fluid conduits arranged to carry fluid from the first outlet of the third heat exchanger to the first heat exchanger via the expansion device, and then to the second inlet of the third heat exchanger; and
a second loop of fluid conduits arranged to carry fluid from the second outlet of the third heat exchanger to the second heat exchanger via the compressor, and then to the first inlet of the third heat exchanger.

Inclusion of the third heat exchanger in this manner may substantially increase (potentially approximately doubling) the rate of heat transfer achievable by the heat transfer assembly for a given level of power consumption by the heat transfer assembly.

The expansion device is configured to reduce the fluid pressure. It may be in the form of a capillary tube, a pressure-controlled valve, an electronic expansion device, or a thermostatic or thermal expansion valve, for example.

A heat transfer assembly as disclosed herein may be arranged such that the first inlet of the third heat exchanger is higher than its first outlet, and/or its second inlet may be lower than its second outlet. This may reduce the likelihood of refrigerant leaving its first outlet in gaseous form and/or refrigerant leaving its second outlet in liquid form. This will tend to improve the efficiency of the heat transfer assembly.

In a further example, the third heat exchanger may be arranged such that its second inlet is higher than its second outlet. In this case, it is preferable that the fluid path between the second outlet and the compressor includes a portion which is at least as high as the second inlet.

In some implementations, a tank level adjustment conduit may be coupled between the cold and hot tanks for carrying liquid between the tanks. This facilitates adjustment of the liquid levels in the tanks if needed.

The system may include a first fluid to air heat exchanger fluidically coupled to the cold tank for transferring heat energy from the ambient atmosphere outside the vehicle to liquid from the cold tank. Accordingly, if the temperature of the liquid in the cold tank falls between below a predetermined threshold, its temperature may be raised by drawing heat energy from the ambient atmosphere.

A second fluid to air heat exchanger may be fluidically coupled to the hot tank for transferring heat energy from liquid from the hot tank to the ambient atmosphere outside the vehicle. Thus, if the temperature of the liquid in the hot tank rises above a predetermined threshold, its temperature may be reduced by dissipating heat energy to the ambient atmosphere.

In a preferred example, the first fluid to air heat exchanger is fluidically coupled to both the cold tank and the hot tank for transferring heat energy from the ambient atmosphere outside the vehicle to liquid from the cold tank and for transferring heat energy from liquid from the hot tank to the ambient atmosphere.

The cold and hot tanks may be fluidically coupled to a liquid to air heat exchanger for exchanging heat energy between liquid from the tanks and air in or to be fed to interior regions of the vehicle to be occupied by users of the vehicle. The system may thereby facilitate control of the temperature in a passenger compartment of a vehicle separately from the temperature of other regions of the vehicle.

The cold and hot tanks may be fluidically coupled to a liquid to air heat exchanger for exchanging heat energy between liquid from the tanks and air in or to be fed to an interior region of the vehicle for holding a battery for powering the vehicle. The system may thereby facilitate control of the temperature in a battery compartment of a vehicle separately from the temperature of other regions of the vehicle.

The system may be arranged to supply liquid for cooling a vehicle drive motor from the cold and/or hot tanks. The system may thereby control the temperature of a drive motor of a vehicle separately from the temperature of other regions of the vehicle. In addition, a greater degree of cooling of the motor may be achievable using the present system, thereby improving the motor performance, particularly in high ambient temperatures.

The present disclosure also provides a method of operating a heating and cooling system of a vehicle as disclosed herein, wherein the method comprises a step of transferring heat energy from the cold tank to the hot tank via the heat transfer assembly. This enables maintenance of the reservoirs of liquid held in the tanks at significantly different temperatures to facilitate efficient use of heat energy within the vehicle for temperature control.

A method of operating a heating and cooling system of a vehicle as disclosed herein may comprise a step of transferring heat energy from the ambient atmosphere outside the vehicle to liquid which is fed to the cold tank via a fluid to air heat exchanger and/or a step of transferring heat energy from liquid from the hot tank to the ambient atmosphere outside the vehicle via a (or the) fluid to air heat exchanger.

A method of operating a heating and cooling system of a vehicle as disclosed herein may comprise a step of transferring heat energy from a location in the vehicle to the cold tank and/or a step of transferring heat energy between a location in the vehicle and the hot tank.

A method of operating a heating and cooling system of a vehicle as disclosed herein may comprise a step of transferring heat energy from a vehicle drive motor for driving the vehicle to the cold or hot tank.

A method of operating a heating and cooling system of a vehicle as disclosed herein may comprise a step of transferring heat energy from an interior region of the vehicle for holding a battery for powering the vehicle to the cold tank or a step of transferring heat energy from the hot tank to said interior region.

### BRIEF DESCRIPTION OF THE DRAWINGS

Examples of the present disclosure will now be described with reference to the accompanying schematic drawings, wherein:

FIG. 1 is a diagram representing a refrigeration system;

FIGS. 2A and 2B are diagrams showing two sections of a heating and cooling system according to an example of the present disclosure; and

FIGS. 3 to 11 are diagrams illustrating examples of operation modes of a system according to the present disclosure.

### DETAILED DESCRIPTION

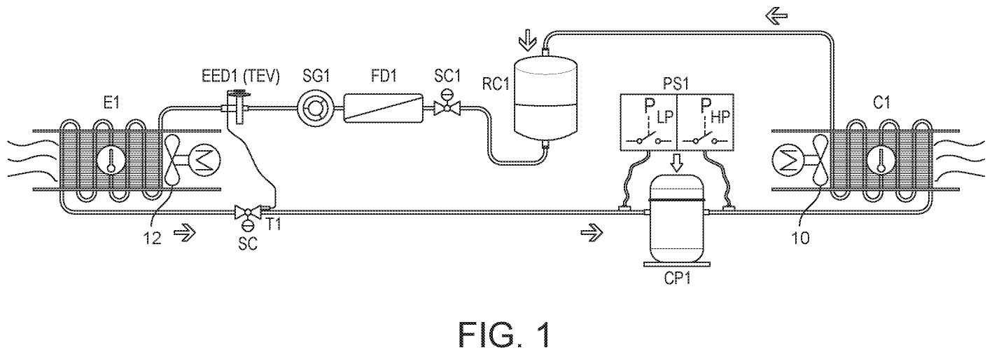

A refrigeration system is shown in FIG. 1 to illustrate features of such a system. Refrigerant vapour is fed to compressor CP1. The compressor then compresses the vapour, reducing its volume by a factor of around 7 to 12. The compressor is controlled by a dual pressure controller PS1 which monitors the vapour pressure on the inlet and outlet of the compressor. The compressed vapour then travels from the compressor into a condenser C1, where it is condensed from gas into liquid. The condenser is cooled by a fan 10 which blows ambient air over the surface of the condenser.

Liquid outputted by the condenser is fed to a refrigerant tank RC1 which separates the liquid from any remaining gas. Downstream of the tank RC1 there is a service connection SC1 which facilitates monitoring of the refrigerant pressure and removal or addition of refrigerant. The connection SC1 is followed by a filter and dryer FD1 for removing moisture from the refrigerant and a sight glass SG1 which allows inspection of the condition of the refrigerant.

The liquid is then fed to an electronic expansion device in the form of a thermostatic expansion valve EED1 (TEV) which sprays high-pressure liquid into a low-pressure evaporator E1 where the refrigerant is vaporised. The TEV is responsive to a temperature sensor Ti which is located downstream of the evaporator. A second fan 12 blows air over the surface of the evaporator which is cooled by the external surface of the evaporator. A second service connection SC2 is provided downstream of the evaporator. The vapour is then fed to the compressor CP1.

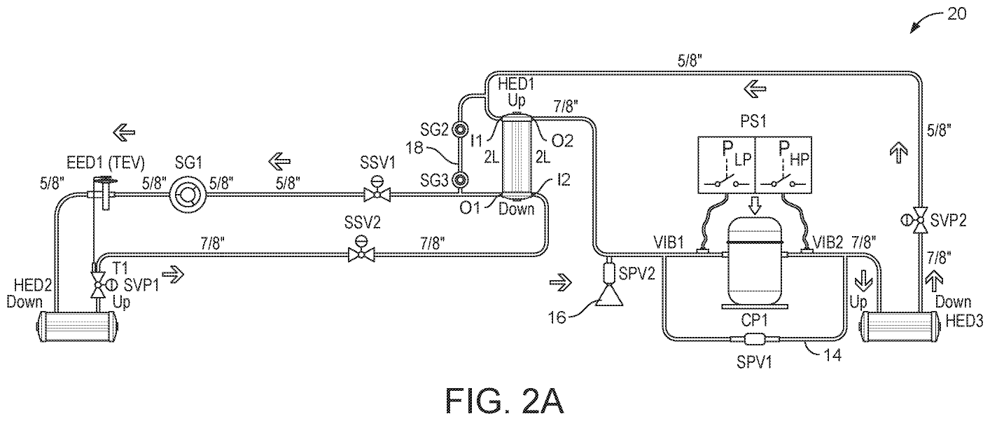

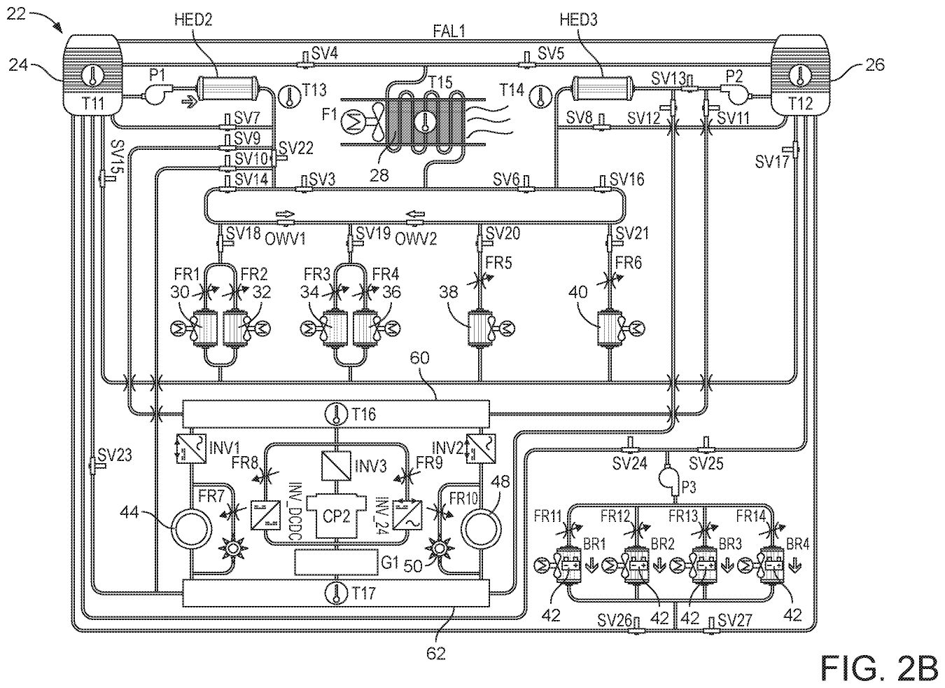

An example of a heating and cooling system according to the present disclosure is shown in FIGS. 2A and 2B. A heat transfer assembly or heat pump section 20 of the system is shown in FIG. 2A, with a heat distribution section 22 of the system shown in FIG. 2B.

The heat transfer assembly 20 of FIG. 2A is configured to transfer heat energy from a heat exchange device HED2 to a heat exchange device HED3. These two devices also form part of the distribution system shown in FIG. 2B.

In the heat transfer assembly of FIG. 2A, refrigerant vapour is fed into a compressor CP1. The compressor then compresses the vapour, reducing its volume by a factor of around 5 to 7.

The inlet and outlet pipes (VIB1 and VIB2) of the compressor are preferably vibration-absorbing pipes in order to absorb vibration of the compressor during its operation. VIB1 and VIB2 are fluidically coupled together via a bypass conduit 14 which is connected in parallel with the compressor CP1 and includes a safety pressure valve SPV1. In addition, upstream of VIB1, a further safety pressure valve SPV2 is included which is coupled to the ambient atmosphere by an exhaust 16.

Vapour leaving the compressor is fed to heat exchange device HED3. The fluid outputted by HED3 (which may consist of liquid together with 1 to 10% of the fluid in vapour form) then travels from the heat exchange device HED3 via a pressure sensor SVP2 to a first inlet I1 of a further heat exchange device, HED1. Liquid leaves the heat exchange device HED1 by a first outlet O1 which is fluidically coupled to the first inlet I1 within HED1.

A liquid indicator 18 is coupled in parallel with the fluid flow from I1 to O1 of HED1 for safety purposes. For example, it may comprise upper and lower sight glasses SG2 and SG3, respectively, to indicate the presence or absence of liquid.

After HED1, the liquid then flows in turn through a service valve SSV1 and sight glass SG1.

Thereafter, the liquid flows to an electronic expansion device in the form of a thermostatic expansion valve EED1 (TEV). The valve sprays high-pressure liquid into the heat exchange device HED2 where it absorbs heat energy and is vaporised. A pressure sensor SVP1 and a service valve SSV3 are located in turn downstream of HED2. Vapour leaving HED2 is then fed into a second inlet I2 of the heat exchange device HED1. The vapour exits HED1 via a second outlet O2 and is fed to the compressor CP1.

Fluid flowing from the first inlet I1 to the first outlet O1 of HED1 flows in the opposite direction to fluid flowing from the second inlet I2 to the second outlet O2. The device HED1 facilitates transfer of heat energy from the fluid entering via the first inlet I1 to the fluid entering via the second inlet I2.

Preferably, the fluid pipes interconnecting the components of the heat transfer assembly 20 have a relatively large internal cross-section to reduce resistance to fluid flow and thereby increase the efficiency of the heat transfer assembly. For example, the pipes may have a diameter of around ⅞ to 1⅜ inches, and preferably no less than ⅝ inches.

The heat transfer assembly configuration shown in FIG. 2A provides a number of benefits. The inlet I1 of HED1 is located higher than the associated outlet O1. This may help to ensure that only liquid is drawn from the outlet, as liquid will tend to collect under gravity in the lower portion of this side of HED1. It therefore assists with separation of the liquid from any remaining vapour.

As heat energy is drawn from the fluid flowing from the first inlet I1 of HED1 to its outlet O1 by fluid flowing from the second inlet I2 to the second outlet O2, the heat exchange device HED1 forms a further condenser stage between I1 and O1.

Furthermore, as fluid flowing from the second inlet I2 of HED1 to its second outlet O2 receives heat energy from fluid travelling from the first inlet I1 to the first outlet O1, HED1 constitutes a further evaporation stage between I2 and O2, converting remaining liquid drops to vapour. As the second outlet is higher than the second inlet, only vapour tends to exit HED1 via its outlet O2, as the vapour will collect in the upper portion of this side of HED1 due to gravity. This serves to improve the efficiency of the compressor CP1 as the raised vapour pressure resulting from heating of the vapour as it passes from I2 to O2 through HED1 allows for a lower compression ratio (and therefore an increased coefficient of performance). Also, the amount of liquid reaching the compressor is reduced which would otherwise be likely to impair its performance and efficiency. Furthermore, the heat transfer achieved by HED1 increases the pressure of the vapour leaving outlet O2 and as a result, less work needs to be done by the compressor to compress the refrigerant to a desired pressure.

In an alternative configuration, inlet I2 may be located higher than outlet O2. Thus, in the example shown in FIG. 2A, the inlet I2 may be connected to HED1 at the location where O2 is connected in FIG. 2A, and vice versa. If the fluid conduit coupling O2 to the compressor CP1 at some point rises to the height of inlet I2 or above, this similarly means that only vapour will tend to reach the compressor, even if the rate of heat transfer by HED1 is reduced during periods when the compressor is not running.

This alternative configuration for I2 and O2 may also be desirable if the compressor does not have an oil separator, as it may enhance the flow of an oil component of the refrigerant returning to the compressor. The velocity of the vaporised component of the refrigerant will tend to carry the oil out of the outlet O2 and lift it through the raised portion of the conduit between HED1 and the compressor. Otherwise, the oil would be likely to collect in HED1.

Preferably, the heat transfer area of HED1 is at least 75% of the heat transfer area of HED2.

It is preferable to use a relatively large heat exchanger as HED1. This enables the heat exchanger to provide a high rate of heat transfer. It also allows the heat exchanger to store liquid which may collect between inlet I1 and outlet O1 and to store gas which may collect between inlet I2 and outlet O2. For example, for every kW of system power, HED1 preferably has an internal volume of at least 1.51 for each of its two flow paths. The system power may for example be defined by the product of its coefficient of performance (COP) and the power rating of the compressor. The internal volume of HED1 for each side may range from 1 to 10 l for relatively small systems, to over 10 l for larger systems, for example.

HED1 is preferably in the form of a plate heat exchanger. The external shape of the heat exchanger may be profiled as appropriate, for example, to suit the space available, whilst maintaining the required heat transfer area and internal volume.

The heat distribution arrangement 22 shown in FIG. 2B includes a cold tank 24 and a hot tank 26 for holding respective reservoirs of liquid coolant.

The flow of coolant around the heat distribution arrangement via a network of pipes is controllable by means of solenoid valves, denoted SV1 to SV27 in FIG. 2B. The temperature at different locations is monitored using temperature sensors denoted T11 to T17.

The heating and cooling system may include a controller for controlling the solenoid valves, pumps and other components of the system in response to signals received from temperature sensors and other control parameters. The controller may be a dedicated programmable controller or control unit (or formed by multiple controllers). The controller may be configured to determine the most appropriate way to operate the system in order to achieve and/or maintain temperatures within the ranges required in different regions of the vehicle, having regard to the thermal properties of the different regions, the ambient temperature and the current temperatures in different compartments of the vehicle.

A pump P1 is fluidically coupled between the cold tank 24 and the heat exchange device HED2 and the heat distribution arrangement is configured to be able to circulate coolant between the cold tank 24 and HED2. Similarly, a pump P2 is fluidly coupled between the hot tank 26 and the heat exchange device HED3 and arranged to be able to circulate coolant between the hot tank 26 and HED3. As a result of the transfer of heat energy from HED2 to HED3 by the heat transfer assembly 20, the circulation of coolant via HED2 and HED3 by the pumps P1 and P2, respectively, will tend to cool the coolant held in the cold tank 24 and heat up the coolant held in hot tank 26.

Each tank may have a capacity of around 1.5 to 4 litres for example. The pumps P1 may for example be able to pump up to around 40 litres/minute.

A fluid conduit FAL1 directly couples the cold tank 24 and the hot tank 26 to each other. It is configured to transfer coolant liquid from one tank to the other if a predetermined level is exceeded in either tank, for example due to a valve fault.

Each of the cold and hot tanks 24, 26 is fluidically coupled to a common fluid-to-air heat exchanger in the form of a radiator 28. The radiator is exposed to the ambient atmosphere surrounding the vehicle. A fan F1 is arranged to blow ambient air over the surface of the radiator.

If the temperature of the coolant in the cold tank 24 falls below a predetermined threshold, the system may be controlled to circulate coolant from the tank through the radiator 28 so as to draw heat energy into the coolant from the ambient atmosphere.

If the temperature of the coolant in the hot tank exceeds a predetermined threshold, the system may be controlled to circulate coolant from the hot tank through the radiator 28 so as to dissipate heat energy from the coolant into the ambient atmosphere.

The heat distribution arrangement 22 is configured to circulate coolant from each of the cold and hot tanks to and from different regions of the vehicle. In the example shown in FIG. 2B, three different types of region are illustrated, namely (i) fluid-to-air heat exchangers located in the driver and passenger compartments, (ii) fluid-to-air heat exchangers located in the drive battery compartment, and (iii) the drive motor compartment.

In FIG. 2B, six fluid-to-air heat exchangers are shown for the passenger compartment, namely two exchangers 30, 32 for heating or cooling an upper deck, two exchangers 34, 36 for heating or cooling a driver's cabin, an exchanger 38 for heating or cooling a lower deck area, and an exchanger 40 for heating or cooling a rear portion of the upper deck. Two one-way valves OWV1 and OWV2 are included to facilitate selection of different combinations of exchangers. It will be appreciated that different exchanger configurations may be selected to suit different vehicles.

Each of the exchangers has an associated flow restriction device (denoted FR1 to FR6, respectively) to facilitate control and/or adjustment of their relative rates of heat transfer. The flow restriction devices may be narrow pipes, electrically controlled valves or thermostatic valves, for example.

The drive battery compartment contains four batteries 42. The heat distribution arrangement 22 includes respective fluid-to-air heat exchangers BR1 to BR4 adjacent to corresponding batteries. A pump P3 is provided for pumping coolant to the drive battery compartment. It may for example be able to pump up to around 1.8 litres/minute. Each of the exchangers BR1 to BR4 has an associated flow restriction device (denoted FR11 to FR14, respectively) to facilitate adjustment of the relative rates of heat transfer delivered by their respective heat exchangers.

The drive motor compartment contains various components for driving and operating the vehicle which require cooling. In FIG. 2B, by way of example only, they include a first motor having a stator 44 and a rotor 46, an associated inverter INV1, and a second motor having a stator 48 and a rotor 50, together with an associated inverter INV2. Each motor is adapted for direct liquid cooling of its stator and rotor, such as for example the APM200 motor manufactured by the present applicant. The drive motor compartment may contain further inverters INV_DCDC, INV_24, INV3, an air compressor CP2 and the gearbox G1, for example.

Flow restriction devices FR7 to FR10 are located in the drive motor compartment in the flow of fluid coolant immediately ahead of rotor 46, INV_DCDC, INV_24 and rotor 50, respectively.

Conduits for carrying fluid coolant to and from components in the drive motor compartment run from an input manifold 60 to an output manifold 62. The temperatures of the manifolds are detected by respective temperature sensors T16 and T17 to facilitate monitoring of the heat dissipation occurring in the drive motor compartment.

It will be appreciated that the arrangement of conduits and valves shown in the FIG. 2B is shown by way of example only and that other configurations may be used to provide similar functionality. For example, three-way valves may be deployed at some points to replace some two-way valves, thereby simplifying the construction, and reducing cost and weight.

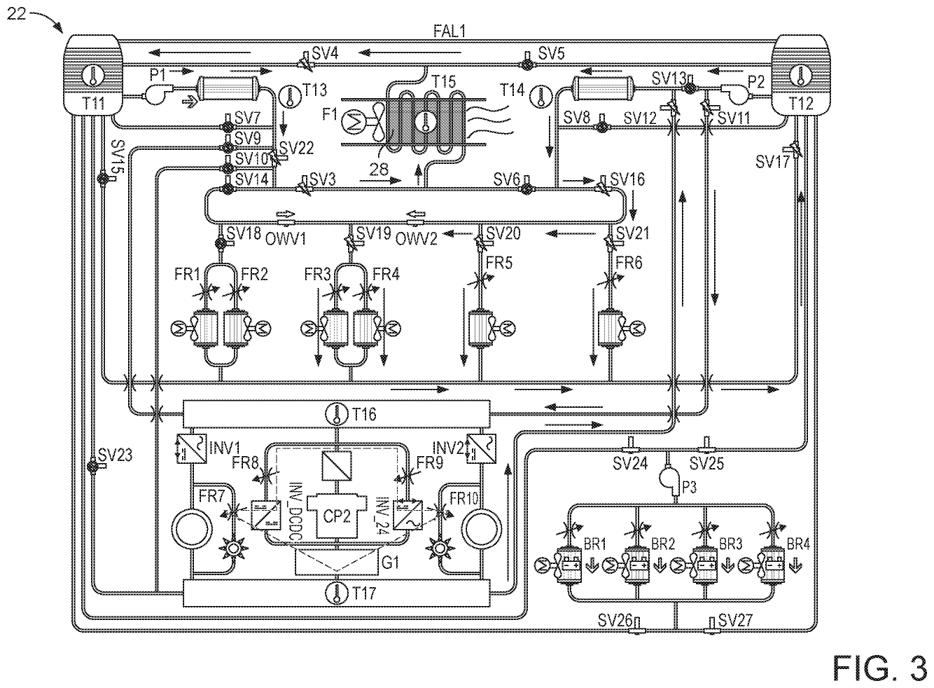

Heating and cooling systems configured in accordance with the present disclosure are able to manage the temperature distribution in a vehicle in a highly efficient and versatile manner. By way of illustration, a selection of different modes of the example system shown in FIGS. 2A and 2B will now be described with reference to FIG. 3 to 11.

FIGS. 3 to 11 show the heat distribution arrangement 22 of FIG. 2B in various operation modes dictated by selective opening of solenoid valves and by selective operation of coolant pumps of the assembly. A lightning symbol is used to denote solenoid valves that have been actuated to open, whilst a symbol consisting of a circle with a diagonal line across it is used to identify closed solenoid valves. Arrows have been added to indicate the flow of coolant.

In FIG. 3, the heat distribution arrangement 22 is shown as operating to (a) cool the drive motor compartment using coolant from the hot tank, (b) heat the passenger compartment using the coolant circulated via the drive motor compartment and the heat exchange device HED3, and (c) raise the temperature of the coolant in the cold tank by circulating coolant via the radiator 28. In this mode, heat energy extracted from the drive motor compartment can be directly used to warm the passenger compartment.

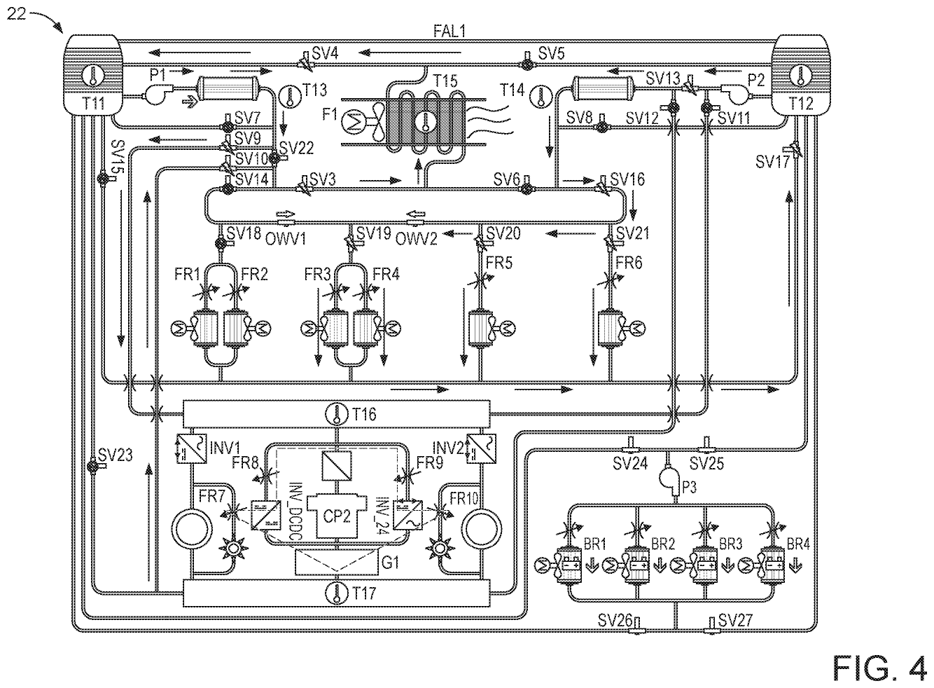

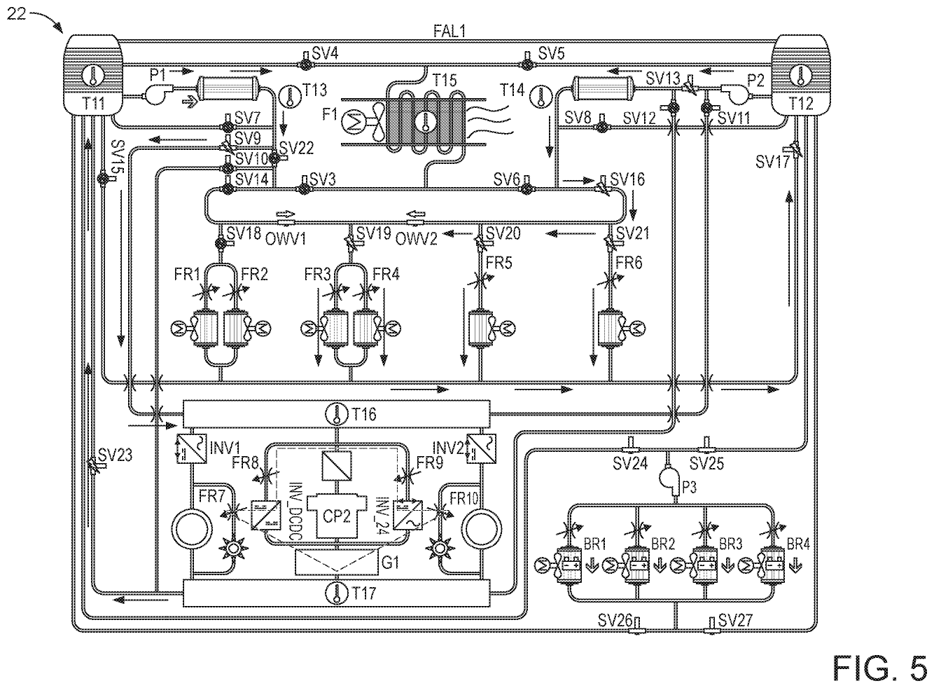

In the operation mode depicted in FIG. 4, the heat distribution arrangement is (a) heating the passenger compartment using coolant drawn from the hot tank via HED3, and (b) cooling the drive motor compartment at a greater rate (in comparison to FIG. 3 where the drive motor compartment is cooled using coolant from the hot tank) in a “boost cooling” mode by circulating coolant through the drive motor compartment which is drawn from the cold tank via HED2. The coolant returning to the cold tank from the drive motor compartment is shown as doing so via the radiator 28. In this way, some of the heat energy extracted from the drive motor compartment will be emitted to the ambient atmosphere. Alternatively, the returning coolant may be directed to return directly to the cold tank without passing through the radiator in order to retain more of the heat energy extracted from the drive motor compartment within the vehicle for use in heating another region of the vehicle. This variation is shown in FIG. 5. Heat energy may be extracted from coolant in the cold tank via HED2, and then transferred to HED3 (via the heat transfer assembly 20) for use in heating a region of the vehicle.

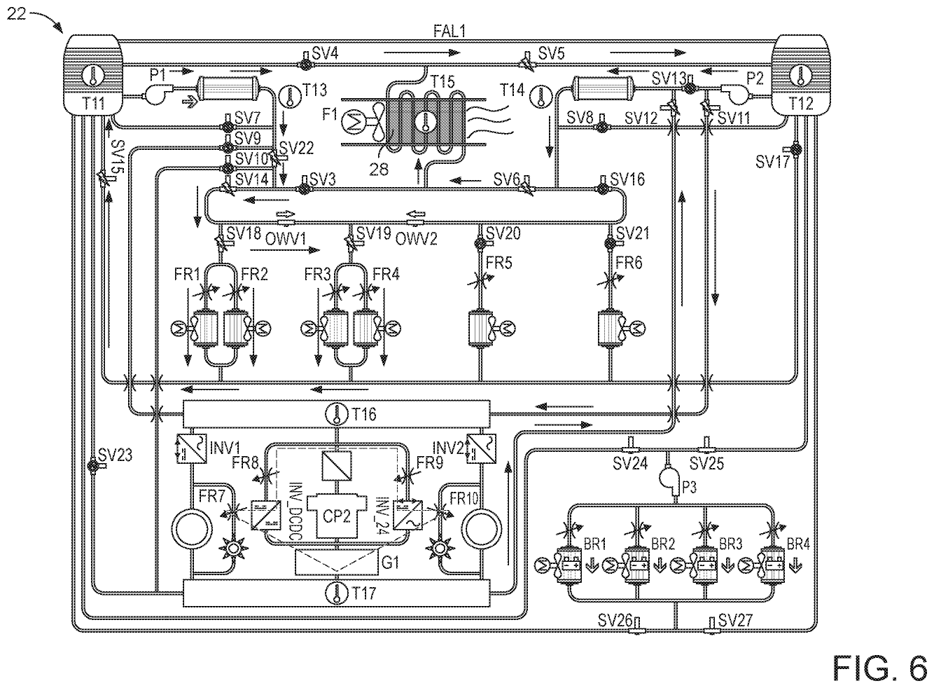

FIG. 6 depicts a mode in which (a) the passenger compartment and the driver's cabin are cooled using coolant drawn from the cold tank, and (b) the motor compartment is cooled by coolant drawn from the hot tank, which is returned to the hot tank via the radiator 28.

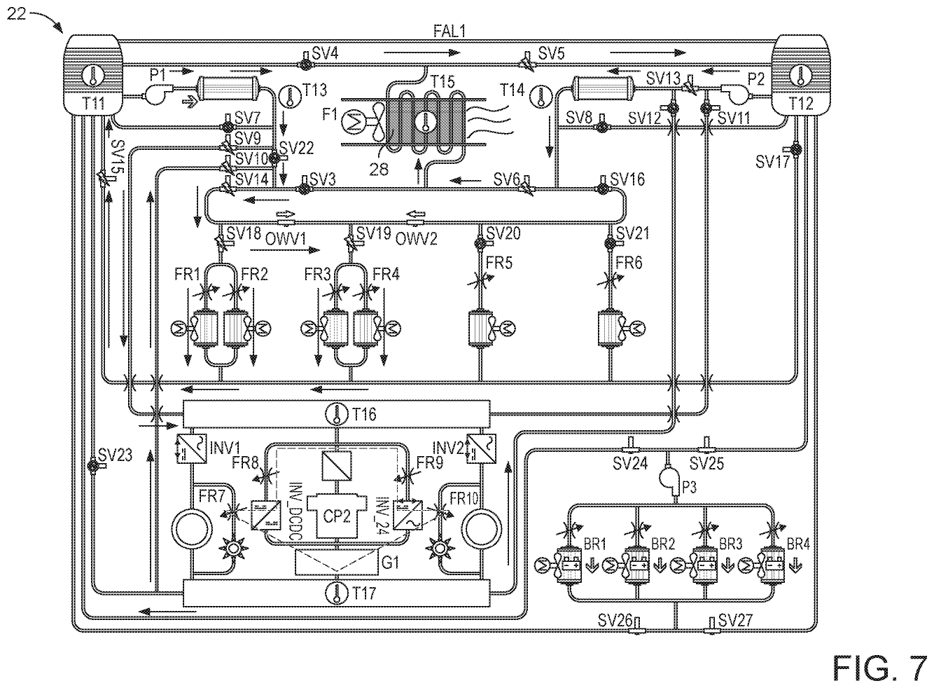

In the configuration depicted in FIG. 7, (a) the passenger compartment, the driver's cabin and the drive motor compartment are cooled using coolant drawn from the cold tank, and (b) excess heat energy is dissipated from the system by circulating coolant from the hot tank via the radiator 28.

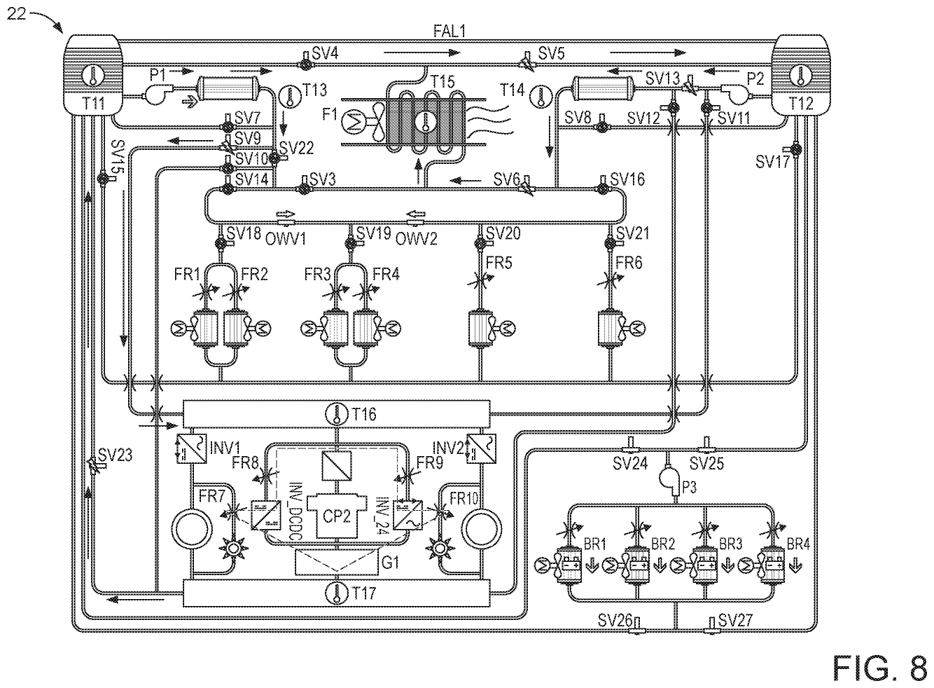

In FIG. 8, (a) the drive motor compartment is cooled in the “boost cooling” mode by circulating coolant through the drive motor compartment from the cold tank via HED2, and (b) excess heat energy is dissipated from the system by circulating coolant from the hot tank via the radiator 28.

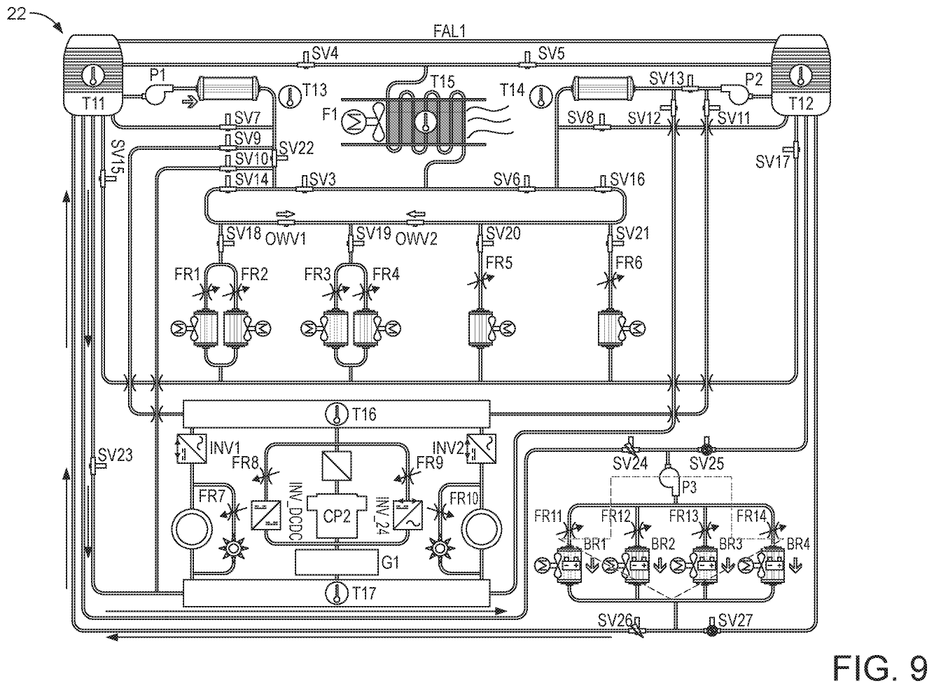

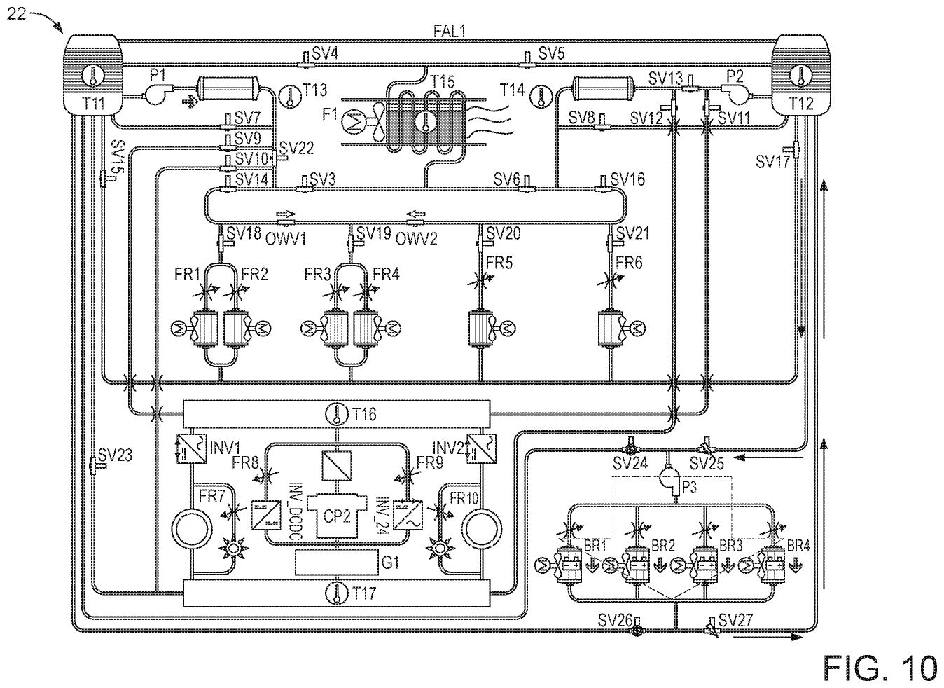

FIGS. 9 and 10 illustrate how the heat distribution arrangement 22 is configured to either heat or cool the battery compartment independently of other regions of the vehicle with a view to optimising the performance and lifetime of the batteries. In the mode shown in FIG. 9, the battery compartment is cooled using coolant drawn from the cold tank, whilst in FIG. 10, the battery compartment is warmed using coolant drawn from the hot tank.

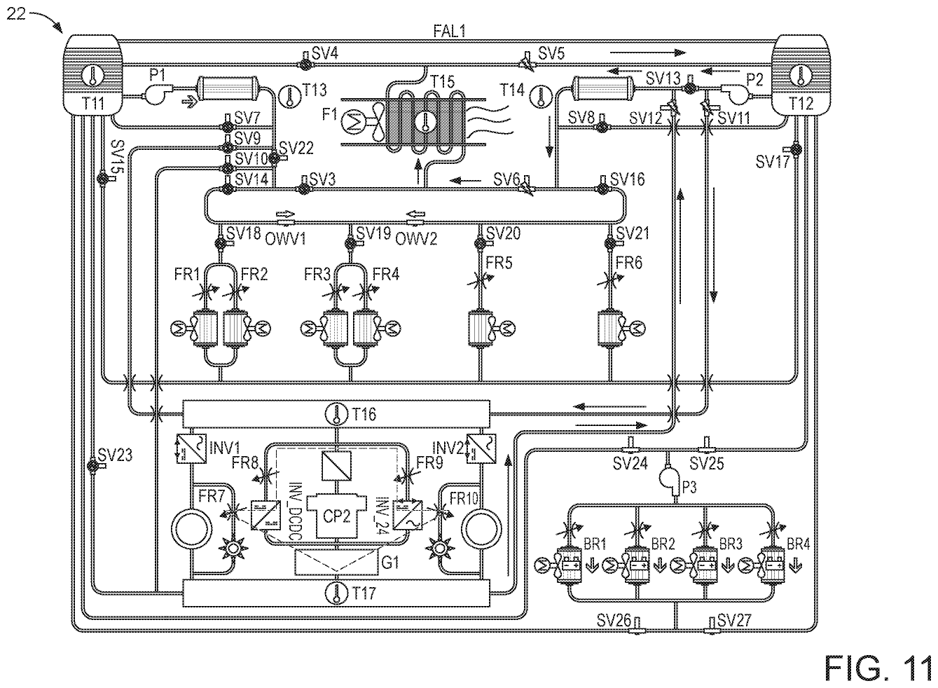

FIG. 11 shows cooling of the drive motor compartment using coolant drawn from the hot tank, with excess heat energy being dissipated from the system by returning coolant to the hot tank via the radiator 28.

1. A heating and cooling system for a vehicle, comprising:
a heat transfer assembly having a first heat exchanger and a second heat exchanger and configured to receive heat energy at the first heat exchanger, transfer heat energy from the first heat exchanger to the second heat exchanger and output heat energy at the second heat exchanger, and
a liquid coolant distribution system comprising:
a cold tank for a first liquid reservoir;
a hot tank for a second liquid reservoir; and
a network of fluid conduits coupling:
the cold tank to the first heat exchanger,
the hot tank to the second heat exchanger, and
the cold and hot tanks to locations in the vehicle to be heated or cooled using liquid from the tanks.

2. The system of claim 1, wherein the heat transfer assembly includes:
a third heat exchanger having first and second fluid inlets and first and second fluid outlets, wherein the third heat exchanger is arranged to transfer heat energy from fluid flowing from the first inlet to the first outlet to fluid flowing from the second inlet to the second outlet;
an expansion device;
a compressor;
a first loop of fluid conduits arranged to carry liquid from the first outlet of the third heat exchanger to the first heat exchanger via the expansion device, and then to the second inlet of the third heat exchanger; and
a second loop of fluid conduits arranged to carry liquid from the second outlet of the third heat exchanger to the second heat exchanger via the compressor, and then to the first inlet of the third heat exchanger.

3. A heat transfer assembly comprising:
a first heat exchanger and a second heat exchanger, wherein the assembly is configured to receive heat energy at the first heat exchanger, transfer heat energy from the first heat exchanger to the second heat exchanger and output heat energy at the second heat exchanger;
a third heat exchanger having first and second fluid inlets and first and second fluid outlets, wherein the third heat exchanger is arranged to transfer heat energy from fluid flowing from the first inlet to the first outlet to fluid flowing from the second inlet to the second outlet;
an expansion device;
a compressor;
a first loop of fluid conduits arranged to carry liquid from the first outlet of the third heat exchanger to the first heat exchanger via the expansion device, and then to the second inlet of the third heat exchanger; and
a second loop of fluid conduits arranged to carry liquid from the second outlet of the third heat exchanger to the second heat exchanger via the compressor, and then to the first inlet of the third heat exchanger.

4. The system of claim 2, wherein the third heat exchanger is arranged such that its first inlet is higher than its first outlet.

5. The system of claim 2, wherein the third heat exchanger is arranged such that its second inlet is lower than its second outlet.

6. The system of claim 2, wherein the third heat exchanger is arranged such that its second inlet is higher than its second outlet, and a fluid path defined by the second loop of fluid conduits between the second outlet and the compressor includes a portion which is at least as high as the second inlet.

7. The system of claim 2, including a tank level adjustment conduit coupled between the cold and hot tanks for carrying liquid between the tanks.

8. The system of claim 2, including a first liquid to air heat exchanger fluidically coupled to the cold tank for transferring heat energy from the ambient atmosphere outside the vehicle to liquid from the cold tank.

9. The system of claim 2, including a second liquid to air heat exchanger fluidically coupled to the hot tank for transferring heat energy from liquid from the hot tank to the ambient atmosphere outside the vehicle.

10. The system of claim 8, wherein the first liquid to air heat exchanger is also fluidically coupled to the hot tank for transferring heat energy from liquid from the hot tank to the ambient atmosphere outside the vehicle.

11. The system of claim 2, wherein the cold and hot tanks are fluidically coupled to a liquid to air heat exchanger for exchanging heat energy between liquid from the tanks and air in or to be fed to interior regions of the vehicle to be occupied by users of the vehicle.

12. The system of claim 2, wherein the cold and hot tanks are fluidically coupled to a liquid to air heat exchanger for exchanging heat energy between liquid from the tanks and air in or to be fed to an interior region of the vehicle for holding a battery for powering the vehicle.

13. The system of claim 2, wherein the system is arranged to supply liquid for cooling a vehicle drive motor from the cold and/or hot tanks.

14. A method of operating the system of claim 1, comprising the step of transferring heat energy from the cold tank to the hot tank via the heat transfer assembly.

15. A method of operating the system of claim 1, or a method of claim 14 comprising the step of transferring heat energy from the ambient atmosphere outside the vehicle to liquid which is fed to the cold tank via a liquid to air heat exchanger.

16. A method of operating the system of claim 1, comprising the step of transferring heat energy from liquid from the hot tank to the ambient atmosphere outside the vehicle via a liquid to air heat exchanger.

17. A method of operating the system of claim 1, comprising the step of transferring heat energy from a location in the vehicle to the cold tank.

18. A method of operating the system of claim 1, comprising the step of transferring heat energy between a location in the vehicle and the hot tank.

19. A method of operating the system of claim 1, comprising the step of transferring heat energy from a vehicle drive motor to the cold tank or the hot tank.

20. A method of operating the system of 1, comprising the step of transferring heat energy from an interior region of the vehicle for holding a battery for powering the vehicle to the cold tank or the step of transferring heat energy from the hot tank to the interior region.
